(19) United States
(12) Patent Application Publication
(10) Pub. No.: US 2024/0427807 A1
(43) Pub. Date: Dec. 26, 2024

(54) FUNNEL TECHNIQUES FOR NATURAL LANGUAGE TO API CALLS

(71) Applicant: CrowdStrike, Inc., Sunnyvale, CA (US)

(72) Inventors: Dragos Corlatescu, Ploiesti (RO); Dan Belibov, Bucharest (RO); Daniel Radu, Bucharest (RO); Elena Budau, Bucharest (RO); Marian Radu, Bucharest (RO)

(21) Appl. No.: 18/461,305

(22) Filed: Sep. 5, 2023

Related U.S. Application Data
(60) Provisional application No. 63/509,927, filed on Jun. 23, 2023.

(51) Int. Cl. G06F 16/332; G06F 16/335; G06F 40/284

(52) U.S. Cl. CPC G06F 16/3325; G06F 16/335; G06F 40/284

(57) ABSTRACT

The present disclosure produces a first output in response to inputting a first prompt into a large language model (LLM). The first prompt comprises a first document group that corresponds to a second document group, and the LLM is limited by a maximum token limit that is less than a token count of the second document group. The present disclosure generates a second prompt that comprises a subset of the second document group corresponding to the first output. The present disclosure then produces a second output based on the subset of the second document group in response to inputting the second prompt into the LLM.

### CROSS-REFERENCE TO RELATED APPLICATIONS

This application claims priority from and the benefit of United States Provisional Patent Application No. 63/509,927 filed Jun. 23, 2023, the entire contents of which are incorporated herein by reference.

### TECHNICAL FIELD

Aspects of the present disclosure relate to large language models (LLMs), and more particularly, to funnel techniques for transforming natural language to Application Programming Interface (API) calls.

### BACKGROUND

Large language models are designed to understand and generate coherent and contextually relevant text. A large language model typically receives input text in the form of a system prompt. The system prompt may include various components such as a question and contextual information to assist the large language model in answering the question. The large language model then converts the system prompt into tokens. A token refers to a unit or element into which a piece of text is divided during a tokenization process. Tokens may represent various elements of the text, such as individual words, sub words, or characters. Each token is typically assigned a unique numerical identifier (ID) that corresponds to its representation in the large language model's vocabulary.

The large language model uses the tokens as input to generate an output through token-based language modeling. During inference or generation, the large language model employs a decoding process where the large language model produces coherent and contextually appropriate responses.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system that processes queries in a multi-service big platform system, in accordance with some embodiments of the present disclosure.

FIG. 2 is a is a diagram that illustrates an example of partitioning documents of a multi-service big platform system into hierarchical document groups, in accordance with some embodiments of the present disclosure.

FIG. 3 is a block diagram that illustrates an example system of iteratively traversing through a LLM funnel chain while generating prompts that are less than the LLM maximum token limit, in accordance with some embodiments of the present disclosure.

FIG. 4 is a flow diagram of a method for processing a user query in a multi-service big platform system, in accordance with some embodiments of the present disclosure.

FIG. 5 is a block diagram that illustrates an example system for processing a user query in a multi-service big platform system, in accordance with some embodiments of the present disclosure.

FIG. 6 illustrates a diagrammatic representation of a machine in the example form of a computer system within which a set of instructions, for causing the machine to perform any one or more of the methodologies discussed herein for processing a query.

### DETAILED DESCRIPTION

As discussed above, a large language model (LLM) typically receives input text in the form of a system prompt that may include various components such as a question and contextual information to assist the large language model in answering the question. The system prompt may be generated from document groups using various techniques, such as data collection, preprocessing, segmentation, prompt generation, formatting, and validation. Data collection refers to collecting a diverse set of document groups that cover a wide range of topics or specific domains based on the intended application. Preprocessing refers to preprocessing the collected documents to remove irrelevant information or noise, which may involve removing headers, footers, citations, or other content that is not relevant to the prompt generation process. Segmentation refers to segmenting the documents into smaller units, such as paragraphs or sentences, to facilitate the generation of system prompts. Prompt generation refers to generating prompts by selecting a representative subset of segments. Formatting refers to formatting the selected segments into appropriate prompts, which may involve adding additional context or instructions to guide the LLM's response. Validation refers to reviewing and validating the prompts to ensure their quality and coherence.

When an LLM is integrated into a multi-service big platform system, the LLM may have difficulty in possessing comprehensive domain expertise and specific knowledge related to each of the various services. While the LLM can generate generic responses, the LLM may lack detailed understanding of the intricacies and nuances of the different services, which results in inaccurate or incomplete information being provided to users. Along these lines, different services often have their own jargon, terminologies, and context-specific requirements. The LLM may face difficulties in correctly interpreting and generating content that aligns with the specific language and context of each service, thereby leading to confusion or miscommunication when integrating the LLM into the multi-service big platform system.

To assist the LLM in multi-service big platform systems to produce accurate answers, additional context may be included in the system prompt such as general text documentation and detail text documentation. The detail text documentation may include, for example, API endpoint documentation when the LLM is requested to output or execute an API call. API endpoints are URLs (Uniform Resource Locators) through which clients can access and interact with individual services. API endpoint documentation refers to a comprehensive set of instructions, guidelines, and details that describe the various endpoints exposed by the corresponding API. API endpoint documentation typically includes the available endpoints, their methods (e.g., GET, POST, PUT, DELETE), required parameters, possible response formats (e.g., JSON, XML), and authentication or authorization requirements.

API endpoint documentation, however, may be lengthy due to the included amount of detail. A challenge found with using lengthy documentation with an LLM is that when the lengthy documentation is converted into tokens, the amount of tokens from the conversion exceeds a maximum amount of tokens that the LLM can support, referred to as a “maximum token limit” or a “maximum input length.” When the LLM encounters input text (including the question and support documentation) that converts to tokens exceeding the LLM's maximum token limit, the LLM may truncate or omit tokens (e.g., text). As such, the LLM may lose context or fail to understand the complete meaning of the input, which can lead to inaccurate or incomplete responses. In addition, because the LLM relies on the context provided by the surrounding tokens to generate meaningful responses, when tokens are truncated, the context window shrinks, potentially affecting the LLM's ability to capture the full context, which may result in less accurate or less coherent outputs. Due to the foregoing, the LLM does not perform well with multi-service big platform systems.

The present disclosure addresses the above-noted and other deficiencies by using an LLM funnel chain in conjunction with hierarchically layered documentation to produce a desired output. In some embodiments, the present disclosure provides an approach of including a first document group into a first prompt and inputting the first prompt into the LLM to produce a first output. Based on the first output, the approach generates a second prompt that includes a subset of a second document group. The first document group corresponds to the second document group, and the second document group corresponds to a token count that is greater than a maximum token limit of the LLM. The approach inputs the second prompt into the LLM and the LLM produces a second output.

In some embodiments, the first prompt includes a user query and the second output includes one or more API calls. The approach executes the API calls to produce a query result corresponding to the user query. The approach then provides the query result to a user interface. In some embodiments, the first output includes one or more identifiers based on the user query. The approach selects one or more documents from the second document group based on the identifiers, and includes the selected documents into the subset of the second document group.

In some embodiments, a first LLM produces the first output, a second LLM produces the second output, and a third LLM is downstream from the first LLM and upstream from the second LLM. Based on the first output, the approach generates a third prompt that includes a subset of a third document group. The approach inputs the third prompt into the third LLM, and the third LLM produces a third output that includes one or more identifiers corresponding to a portion of the subset of the third document group. The approach then generates the second prompt based on the identifiers included in the third output. In some embodiments the first LLM, second LLM, and third LLM may be the same LLM.

In some embodiments, the approach identifies one or more documents from the second document group that corresponds to the first output. The approach determines whether a token count of the one or more documents exceeds the maximum token limit of the LLM. In response to determining that the token count of the one or more documents does not exceed the maximum token limit of the LLM, the approach generates the second prompt from the first output to bypass the third LLM.

In some embodiments, the first document group includes a group of services descriptions, the second document group includes a group of API endpoint detail descriptions, the third document group includes a group of API endpoint descriptions, and the second output includes one or more API endpoint calls. Service descriptions provide an overview of the platform's services, endpoint descriptions provide more specific information about individual endpoints, and full endpoint details offer comprehensive technical information about each endpoint to facilitate smooth integration and usage by developers.

In some embodiments, the approach determines that the maximum token limit is less than a token count of the first document group. In response to determining that the maximum token limit is less than a token count the first document group, the approach adds the third LLM to a funnel chain that includes the first LLM and the second LLM; creates the third document group from the first document group; and reduces the first document group to a token count that is less than the maximum token limit.

As discussed herein, the present disclosure provides an approach that improves the operation of a computer system by increasing the speed at which user queries are processed and uses a reduced amount of resources in a multi-service big platform system. In addition, the present disclosure provides an improvement to the technological field of multi-service big platform system queries by enabling the use of large language models to increase the accuracy of processing the queries.

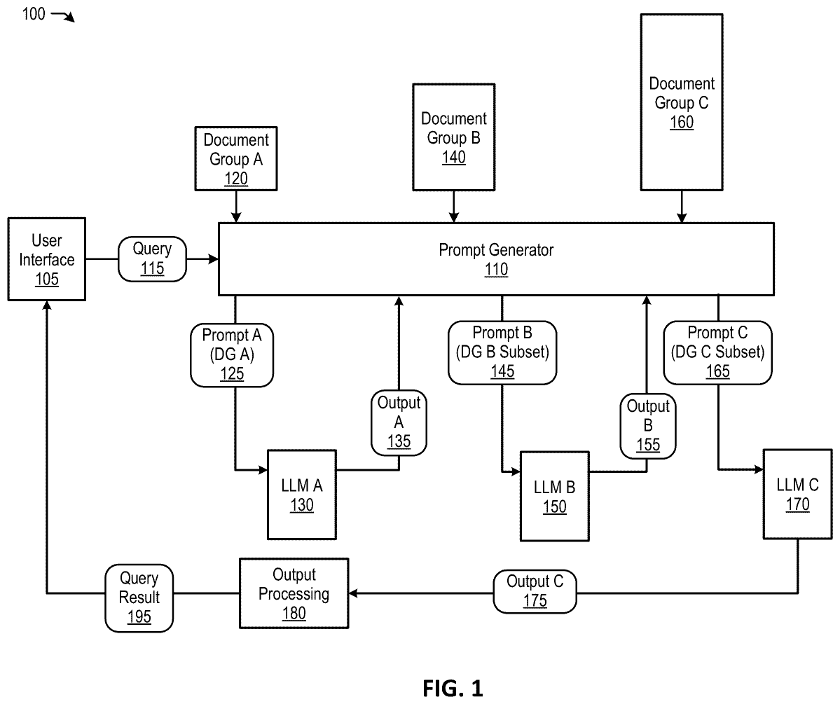

FIG. 1 is a block diagram that illustrates an example system that processes queries in a multi-service big platform system, in accordance with some embodiments of the present disclosure. System 100 uses an LLM funnel chain that includes LLM A 130, LLM B 150, and LLM C 170, and corresponding document groups A 120, B 140, and C 160. In some embodiments, the three LLMs are separate LLMs, while in other embodiments the three LLMs are the same LLM used in three instances. The LLMs are a form of machine learning models (MLMs) and, in some embodiments, the LLMs may also be natural language processing models, deep learning models, other artificial intelligence models, or a combination thereof.

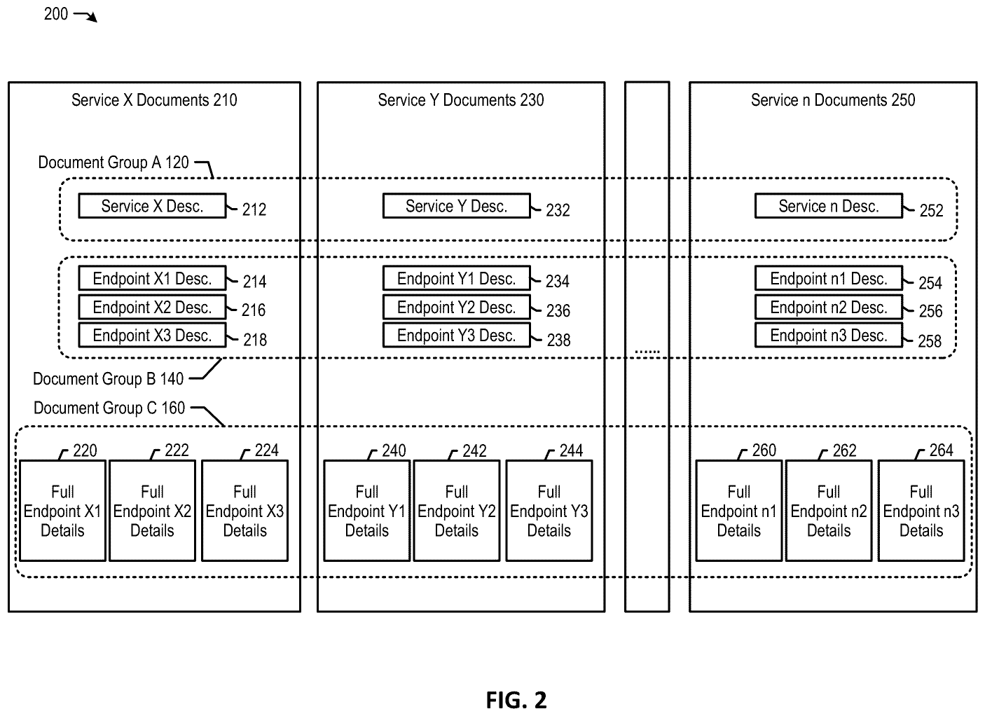

System 100 hierarchically partitions multiple layers of documentation, such as by categorizing API endpoint documentation into groups (see FIG. 2 and corresponding text for further details). The LLM funnel chain then uses the document groups to iteratively navigate through the available information and answer a user's query. In some embodiments, the document groups are separated into service descriptions (document group A 120), endpoints descriptions (document group B 140), and full endpoint details (document group C 160).

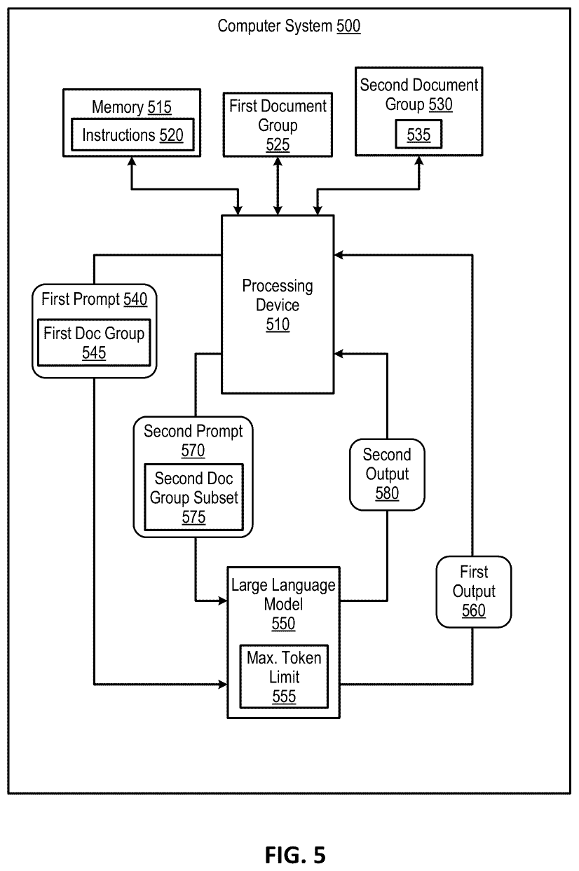

User interface 105 sends query 115 to prompt generator 110. Prompt generator 110 may be, for example, a process executing on a processing device such as processing device 510 shown in FIG. 5. Document group A 120 is configured such that the number of tokens that it produces is less than the maximum token limit of LLM A 130. As such, prompt generator 110 combines query 115 and document group A 120 into prompt A 125. Prompt generator 110 inputs prompt A 125 into LLM A 130, and LLM A 130 produces output A 135. Output A 135 identifies a subset of document group A 120. For example, if document group A 125 includes services 1-10, output A 135 may include identifiers for services 1, 4, and 6.

Prompt generator 110 evaluates output A 135 and identifies a subset of document group B140 that corresponds to output A 135 (e.g., the endpoint descriptions that correspond to services 1, 4, and 6). Prompt generator 110 includes query 115 and the identified subset of document group B140 into prompt B 145 and inputs prompt B 145 into LLM B 150. LLM B 150 produces output B 155, which identifies a portion of the subset of document group B 140 included in prompt B 145. For example, output B 155 may identify one endpoint description from service 4 and one endpoint description from service 6.

Prompt generator 110 evaluates output B 155 and identifies a subset of document group C 160 that corresponds to output B 155, such as full endpoint details corresponding to the identified endpoint descriptions from service 4 and service 6. Prompt generator 110 includes the subset of document group C 160 into prompt C 165 and inputs prompt C 165 into LLM C 170. In turn, LLM C 170 produces output C 175 that, in some embodiments, includes a list of API calls, ordered steps, and a description of how the steps “interact” with each other (e.g., step 1 results may be required in step 2 as parameters).

Output processing 180 receives output C 175 and executes the various API calls in output C 175 to produce a query result 190. Output processing 180 may be, for example, a process executing on a processing device such as processing device 510 shown in FIG. 5. In some embodiments, LLM C 170, or another LLM, generates code from output C 175, executes the code, and provides the results to user interface 105.

In some embodiments, prompt generator 110 evaluates output A 135 to determine whether the output would produce a subset of document group C 160 within a document size window. For example, output A 135 may identify service 3, and the full endpoint details of service 3 are relatively small. In this example, prompt generator 110 may bypass LLM B 150 and include a portion of document group C 160 in prompt C 165 corresponding to service 3.

In some embodiments, system 100 scales based on document size and accommodates evolving plans. The scalable solution allows for the addition of more documentation layers as required, ensuring the successful completion of user tasks even if system prompts become too large at various layers within the LLM funnel chain.

FIG. 2 is a is a diagram that illustrates an example of partitioning documents of a multi-service big platform system into hierarchical document groups, in accordance with some embodiments of the present disclosure. Documents 200 include service X documents 210, service Y documents 230, and service n documents 250, each of which corresponds to a service in a multi-service environment. In some embodiments, such as a large-scale multi-service platform, “service descriptions,” “endpoint descriptions,” and “full endpoint details” are terms used to refer to different levels of information and documentation related to the services and endpoints exposed by the platform. Service descriptions provide a high-level overview of the various services available within the platform, and typically include information about the purpose, capabilities, and functionality of each service. Endpoint descriptions provide more detailed information about each endpoint exposed by a service. Endpoint descriptions may include HTTP methods (GET, POST, PUT, DELETE, etc.) supported by the endpoint, the required parameters, authentication mechanisms, and any response formats (e.g., JSON, XML) that the endpoint returns. Full endpoint details include details about the inner workings of an endpoint. This information may include technical specifications, data models, error codes, rate limits, security considerations, and any other intricacies related to the endpoint's implementation.

Service X documents 210 includes service description 212, endpoint descriptions 214, 216, and 218, and full endpoint details 220, 222, and 224. Service Y documents 230 includes service description 232, endpoint descriptions 234, 236, and 238, and full endpoint details 240, 242, and 244. Service n documents 250 includes service description 252, endpoint descriptions 254, 256, and 258, and full endpoint details 260, 262, and 264.

FIG. 2 shows that document group A 120 includes service descriptions 212, 232, and 252. Document group B 140 includes endpoint descriptions 214, 216, 218, 234, 236, 238, 254, 256, and 256. Document group C 160 includes full endpoint details 220, 222, 224, 240, 242, 244, 260, 262, and 264. In some embodiments, the number of tokens converted from the document groups increase the further down the LLM funnel chain. For example, document group A 120 may convert to 4,000 tokens, document group B 140 may convert to 20,000 tokens, and document group C 160 may convert to 100,000 tokens. Because document group C 160 (and possibly document group B 140) converts to more tokens than the maximum token limit of LLMs 130-170, the system prompts generated by prompt generator 110 and input into downstream LLMs include a subset of the document group that converts to a token count less than a maximum token limit of LLMs 130-170.

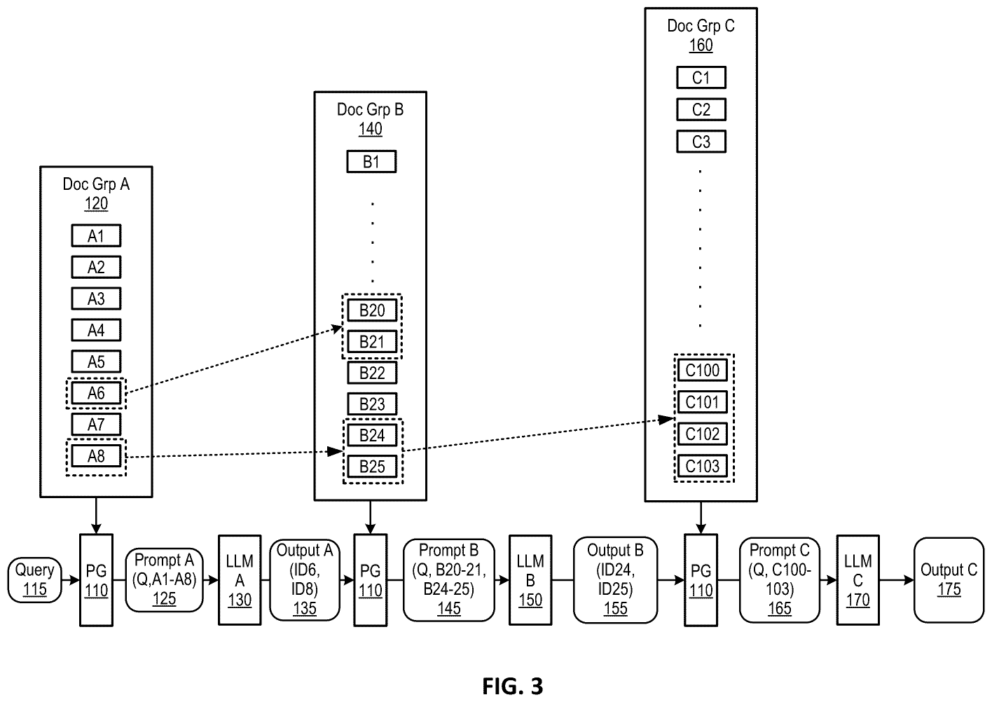

FIG. 3 is a block diagram that illustrates an example system of iteratively traversing through a LLM funnel chain while generating prompts that are less than the LLM maximum token limit, in accordance with some embodiments of the present disclosure. Document group A 120 includes documents A1-A8. Each of the documents may, for example, correspond to a particular service. Document group B 140 includes documents B1 through B25, which each correspond to at least one of documents A1-A8. Document group C 160 includes documents C1-C103, which each correspond to at least one of documents B1-B25.

Prompt generator 110 receives query 115 and includes document group A 120 into prompt A 125 because, for example, the tokenization of document group A 120 does not exceed the maximum token limit of LLM A 130. LLM A 130 processes prompt A 125 and produces output A 135, which includes identifiers that identify documents A6 and A8 that correspond to query 115. Prompt generator 110 evaluates document group B 140 and determines that documents B20 and B21 correspond to document A6, and documents B24 and B25 correspond to document A8. In some embodiments, prompt generator 110 accesses a mapping table to map documents between document group A 120, document group B 140, and document group C 160. Prompt generator 110 includes the corresponding documents B20, B21, B24, and B25 into prompt B 145 and inputs prompt B 145 into LLM B 150.

LLM B 150 evaluates prompt B 145 and produces output B 155, which includes identifiers that identify documents B24 and B25 that correspond to query 115. Prompt generator 110 evaluates output B 155 and determines that documents C100, C101, C102, and C103 correspond to documents B24 and B25. As such, prompt generator 110 includes documents C100 through C103 into prompt C 165 and inputs prompt C 165 into LLM C 170. At this point, in some embodiments, LLM C 170 uses documents C100 through C103 to generate API calls and instructions that correspond to query 115, and include the API calls and instructions in output C 175.

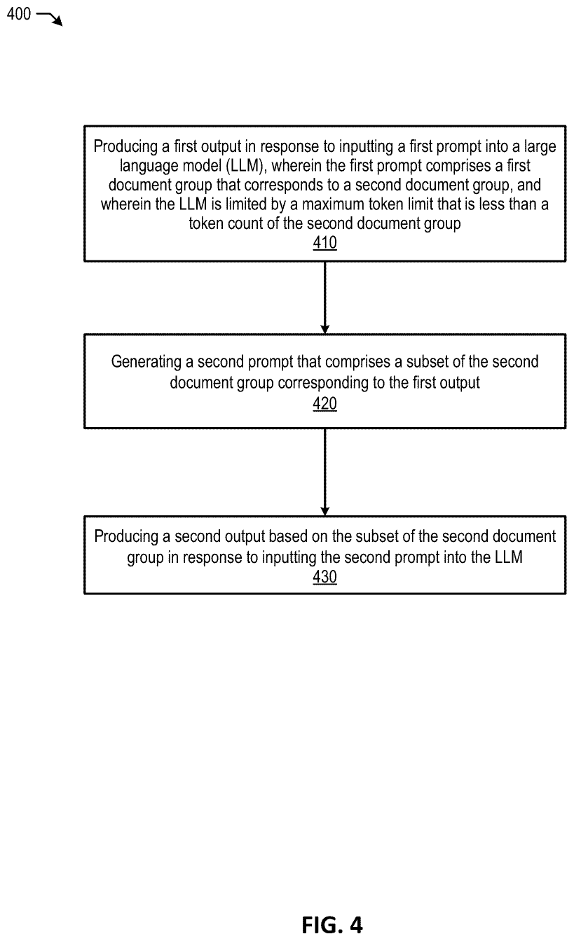

FIG. 4 is a flow diagram of a method for processing a user query in a multi-service big platform system, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by processing device 510 shown in FIG. 5.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic produces a first output in response to inputting a first prompt into an LLM. The first prompt includes a first document group that corresponds to a second document group. For example, the first document group may include high-level information corresponding to a service agent, and the second document group may include detail-level information corresponding to the same service agent. The LLM is limited by a maximum token limit that is less than a token count of the second document group. For example, the first document group may correspond to 2,000 tokens, the second document group may correspond to 60,000 tokens, and the LLM maximum token limit is 4,000 tokens,

At block 420, processing logic generates a second prompt based on the first output. The second prompt includes a subset of the second document group. For example, the subset of the second document group may correspond to 3,000 tokens, which is less than the maximum token limit.

At block 430, processing logic inputs the second prompt into the LLM and the LLM produces a second output based on the subset of the second document group. In some embodiments, the first output is produced by a first LLM, the second output is produced by a second LLM, and a third LLM is downstream from the first LLM and upstream from the second LLM (see FIG. 1 and corresponding text for further details). Based on the first output, processing logic generates a third prompt that includes a subset of a third document group. Processing logic inputs the third prompt into the third LLM, and the third LLM produces a third output that includes one or more identifiers corresponding to a portion of the subset of the third document group. Processing logic then generates the second prompt based on the identifiers included in the third output. In some embodiments, the first document group includes a group of services descriptions that provide an overall understanding of a software service; the second document group includes a group of API endpoint details that provide technical information about how to access an API corresponding to the software services; the third document group includes a group of API endpoint descriptions that provide particular insights into the functionality and usage of the API endpoint; and the second output includes one or more API endpoint calls.

FIG. 5 is a is a block diagram that illustrates an example system for processing a user query in a multi-service big platform system, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to include first document group 545 into first prompt 540 and input first prompt 540 into LLM 550. First document group 525 corresponds to second document group 530. LLM 550 is limited by a maximum token limit 555 that is less than a token count 535 of the second document group 530.

LLM produces first output 560 in response to receiving first prompt 540. For example, a question that may be received is: “Show me detections attributed to actor XYZ.” In this example, first prompt 540 includes the question and endpoints descriptions (first document group 545), and LLM 550 identifies the endpoint descriptions that are related to detections and actors. LLM 550 may use code names such as “query detections,” “get detections,” “aggregate detections,” “query actors,” “get actors,” “aggregate actors,” etc., to identify the corresponding endpoint descriptions. LLM 550 then includes the identified endpoint descriptions in first output 560.

Processing device 510 generates a second prompt 570 based on first output 560 and includes a subset of the second document group (second document group subset 575). Continuing with the example above, processing device 510 selects the full endpoint details from second document group 530 that correspond to the identified endpoint descriptions in first output 560, and includes the selected full endpoint details in second document group subset 575. Processing device 510 also includes the question in second prompt 570 and sends second prompt 570 to LLM 550. LLM 550 then produces second output 580. Continuing with the example above, second output 580 may include a series of steps that completes the request, such as “1) query actors; 2) query detections with the response from step 1; 3) get detections using the response from step 2.” Processing device 510, in some embodiments, then executes the plan programmatically and the response is returned to a user interface. In some embodiments, LLM 550 may be multiple LLMs, may be in a cloud environment, or a combination thereof.

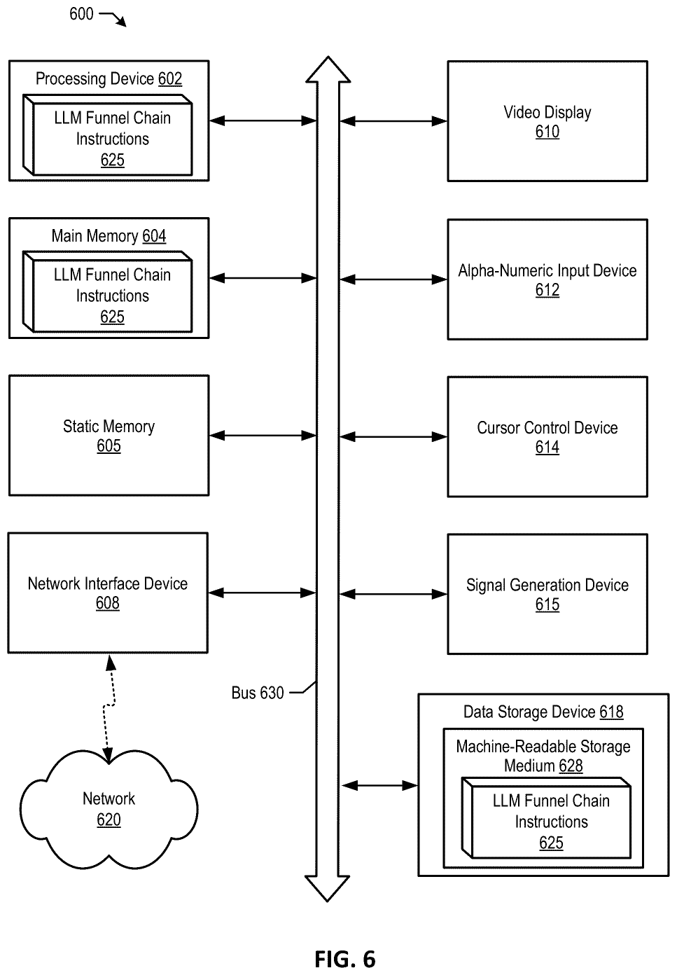

FIG. 6 illustrates a diagrammatic representation of a machine in the example form of a computer system 600 within which a set of instructions, for causing the machine to perform any one or more of the methodologies discussed herein for processing a query.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute funnel chain instructions 625, for performing the operations and steps discussed herein.

The data storage device 618 may include a machine-readable storage medium 628, on which is stored one or more sets of funnel chain instructions 625 (e.g., software) embodying any one or more of the methodologies of functions described herein. The funnel chain instructions 625 may also reside, completely or at least partially, within the main memory 604 or within the processing device 602 during execution thereof by the computer system 600; the main memory 604 and the processing device 602 also constituting machine-readable storage media. The funnel chain instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “producing,” “generating,” “executing,” “providing,” “selecting,” “including,” “inputting,” “identifying,” “determining,” “adding,” “creating,” and/or “reducing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
producing a first output in response to inputting a first prompt into a large language model (LLM), wherein the first prompt comprises a first document group that corresponds to a second document group, and wherein the LLM is limited by a maximum token limit that is less than a token count of the second document group;
generating, by a processing device, a second prompt that comprises a subset of the second document group corresponding to the first output; and
producing a second output based on the subset of the second document group in response to inputting the second prompt into the LLM.

2. The method of claim 1, wherein the first prompt comprises a user query and the second output comprises one or more API (Application Programming Interface) calls, the method further comprising:
executing the one more API calls to produce a query result that corresponds to the user query; and
providing the query result to a user interface.

3. The method of claim 1, wherein the first output comprises one or more identifiers based on a user query, the method further comprising:
selecting one or more documents from the second document group based on the one or more identifiers; and
including the one or more documents from the second document group into the subset of the second document group.

4. The method of claim 1, wherein the first output is produced by a first LLM, the second output is produced by a second LLM, and a third LLM is downstream from the first LLM and upstream from the second LLM, the method further comprising:
generating a third prompt from the first output, wherein the third prompt comprises a subset of a third document group based on the first output;
inputting the third prompt into the third LLM;
producing, by the third LLM, a third output that comprises one or more identifiers corresponding to a portion of the subset of the third document group; and
generating the second prompt based on the one or more identifiers included in the third output.

5. The method of claim 4, further comprising:
identifying one or more documents from the second document group that corresponds to the first output;
determining whether a token count of the one or more documents exceeds the maximum token limit; and
in response to determining that the token count of the one or more documents does not exceed the maximum token limit, generating the second prompt from the first output to bypass the third LLM.

6. The method of claim 4, wherein the first document group comprises a group of services descriptions, the second document group comprises a group of API endpoint detail descriptions, the third document group comprises a group of API endpoint descriptions, and the second output comprises one or more API endpoint calls.

7. The method of claim 4, further comprising:
determining that the maximum token limit is less than a token count of the first document group;
in response to determining that the maximum token limit is less than a token count the first document group:
adding the third LLM to a funnel chain that comprises the first LLM and the second LLM;
creating the third document group from the first document group; and
reducing the first document group to a token count that is less than the maximum token limit.

8. A system comprising:
a processing device; and
a memory to store instructions that, when executed by the processing device cause the processing device to:
produce a first output in response to inputting a first prompt into a machine learning model (MLM), wherein the first prompt comprises a first document group that corresponds to a second document group, and wherein the MLM is limited by a maximum token limit that is less than a token count of the second document group;
generate a second prompt that comprises a subset of the second document group corresponding to the first output; and
produce a second output based on the subset of the second document group in response to inputting the second prompt into the MLM.

9. The system of claim 8, wherein the first prompt comprises a user query and the second output comprises one or more API (Application Programming Interface) calls, and wherein the processing device, responsive to executing the instructions, further causes the system to:
execute the one more API calls to produce a query result that corresponds to the user query; and
provide the query result to a user interface.

10. The system of claim 8, wherein the first output comprises one or more identifiers based on a user query, and wherein the processing device, responsive to executing the instructions, further causes the system to:
select one or more documents from the second document group based on the one or more identifiers; and
include the one or more documents from the second document group into the subset of the second document group.

11. The system of claim 8, wherein the first output is produced by a first large language model (LLM), the second output is produced by a second LLM, and a third LLM is downstream from the first LLM and upstream from the second LLM, and wherein the processing device, responsive to executing the instructions, further causes the system to:
generate a third prompt from the first output, wherein the third prompt comprises a subset of a third document group based on the first output;
input the third prompt into the third LLM;
produce, by the third LLM, a third output that comprises one or more identifiers corresponding to a portion of the subset of the third document group; and
generate the second prompt based on the one or more identifiers included in the third output.

12. The system of claim 11, wherein the processing device, responsive to executing the instructions, further causes the system to:
identify one or more documents from the second document group that corresponds to the first output;
determine whether a token count of the one or more documents exceeds the maximum token limit; and
in response to determining that the token count of the one or more documents does not exceed the maximum token limit, generate the second prompt from the first output to bypass the third LLM.

13. The system of claim 11, wherein the first document group comprises a group of services descriptions, the second document group comprises a group of API endpoint detail descriptions, the third document group comprises a group of API endpoint descriptions, and the second output comprises one or more API endpoint calls.

14. The system of claim 11, wherein the processing device, responsive to executing the instructions, further causes the system to:
determine that the maximum token limit is less than a token count of the first document group;
in response to determining that the maximum token limit is less than a token count the first document group:
add the third LLM to a funnel chain that comprises the first LLM and the second LLM;
create the third document group from the first document group; and
reduce the first document group to a token count that is less than the maximum token limit.

15. A non-transitory computer readable medium, having instructions stored thereon which, when executed by a processing device, cause the processing device to:
produce a first output in response to inputting a first prompt into a large language model (LLM), wherein the first prompt comprises a first document group that corresponds to a second document group, and wherein the LLM is limited by a maximum token limit that is less than a token count of the second document group;
generate, by the processing device, a second prompt that comprises a subset of the second document group corresponding to the first output; and
produce a second output based on the subset of the second document group in response to inputting the second prompt into the LLM.

16. The non-transitory computer readable medium of claim 15, wherein the first prompt comprises a user query and the second output comprises one or more API (Application Programming Interface) calls, and wherein the processing device is to:
execute the one more API calls to produce a query result that corresponds to the user query; and
provide the query result to a user interface.

17. The non-transitory computer readable medium of claim 15, wherein the first output comprises one or more identifiers based on a user query, and wherein the processing device is to:
select one or more documents from the second document group based on the one or more identifiers; and
include the one or more documents from the second document group into the subset of the second document group.

18. The non-transitory computer readable medium of claim 15, wherein the first output is produced by a first LLM, the second output is produced by a second LLM, and a third LLM is downstream from the first LLM and upstream from the second LLM, and wherein the processing device is to:
generate a third prompt from the first output, wherein the third prompt comprises a subset of a third document group based on the first output;
input the third prompt into the third LLM;
produce, by the third LLM, a third output that comprises one or more identifiers corresponding to a portion of the subset of the third document group; and
generate the second prompt based on the one or more identifiers included in the third output.

19. The non-transitory computer readable medium of claim 18, wherein the processing device is to:
identify one or more documents from the second document group that corresponds to the first output;
determine whether a token count of the one or more documents exceeds the maximum token limit; and
in response to determining that the token count of the one or more documents does not exceed the maximum token limit, generate the second prompt from the first output to bypass the third LLM.

20. The non-transitory computer readable medium of claim 18, wherein the processing device is to:
determine that the maximum token limit is less than a token count of the first document group;
in response to determining that the maximum token limit is less than a token count the first document group:
add the third LLM to a funnel chain that comprises the first LLM and the second LLM;
create the third document group from the first document group; and
reduce the first document group to a token count that is less than the maximum token limit.
